(19) United States
(12) Patent Application Publication
(10) Pub. No.: US 2023/0206373 A1
(43) Pub. Date: Jun. 29, 2023

(54) SYSTEM, DEVICE AND METHOD FOR ELECTRONIC IDENTITY VERIFICATION IN LAW ENFORCEMENT

(71) Applicant: MOTOROLA SOLUTIONS, INC., Chicago, IL (US)

(72) Inventors: Matthew E. SIMMS, Chicago, IL (US); Pranay MUCHANDI, Chicago, IL (US); Devin BARRETO, Chicago, IL (US)

(21) Appl. No.: 17/564,493

(22) Filed: Dec. 29, 2021

(51) Int. Cl. G06Q 50/26

(52) U.S. Cl. CPC G06Q 50/265

(57) ABSTRACT

The present specification provides a system, devices and methods for electronic identity verification in law enforcement. The specification provides for at least one data set that contains direct identifiers of persons of interest and indirect identifiers of electronic sources with known geographic locations that are associated with the persons of interest. A query to a server from a communication device operated by a law enforcement personnel can contain signatures detected from the electronic sources and an indication of a direct identity of the person of interest. The server can compare the query to the data sets and calculate a likelihood that the person of interest has been correctly identified.

### BACKGROUND OF THE INVENTION

A crucial function of law enforcement personnel is efficient and accurate location and interaction with persons of interest. Yet, misidentification of persons of interest is a known problem that remains a serious risk that can result in significant harm to all stakeholders and the overall healthy functioning of civil society.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a block diagram representing a system for electronic identity verification in law enforcement.

FIG. 2 is a block diagram representing the components of the server from FIG. 1.

FIG. 3 shows example contents of the primary data set from FIG. 1.

FIG. 4 shows example contents of the secondary data set from FIG. 1.

FIG. 5 is a flow chart representing a method for electronic identity verification in law enforcement.

FIG. 6 shows example performance of a query from law enforcement personnel that results in a verification that a person of interest was correctly identified by the law enforcement personnel.

FIG. 7 shows example performance of a query from law enforcement personnel that results in a verification that a person of interest was incorrectly identified by the law enforcement personnel.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Accurate identification of persons-of-interest (POI) is a serious challenge for law enforcement. Accurate identification can be frustrated by contextual factors such as weather, lighting, clothing, distractions, obscured facial features, imperfect memory and unconscious bias, all of which may be exacerbated by the stress of the law enforcement officer being expected to make a series of complex decisions during an encounter with a potential POI. Misidentification of POI can lead to disastrous consequences, including failure to apprehend dangerous suspects or tragic inadvertent victimization of innocent citizens by the very law enforcement agencies who are tasked with and take pride in protecting them. Law enforcement personnel may also face enormous personal stress in the period following a misidentification, undermining recruitment and retention of skilled law enforcement personnel. Accordingly, correct identification of POI is critical to the integrity and efficiency of the justice system, particularly in democratic societies that value healthy dissent, due process and the maintenance of healthy checks and balances against the state exercising improper influence and control over its citizens, while at the same time not unduly fettering the ability of law enforcement personnel to do their difficult jobs. Despite remarkable recent technological advancements in identification technologies, there remain serious risks of misidentification of persons of interests and the attendant social harm. Indeed, in addition to the societal harms caused by misidentification of persons-of-interest, such misidentification imposes meaningful technological burdens on the limited technological resources of law enforcement communication networks. Thus, there exists a need for an improved technical method, device, and system for electronic identity verification in law enforcement.

An aspect of the present specification provides a computing apparatus for corroborating an identification of a person-of-interest comprising a memory for maintaining a primary data set representing a plurality of direct identifiers each respective to a different person-of-interest of a plurality of persons-of-interest. The memory is also for maintaining a secondary data set representing at least one indirect identifier including: an electronic source, a geographic location of the electronic source and a weighting representing a proximity likelihood for the indirect identifier in relation to one of the persons-of-interest. The computing apparatus also comprises a processing unit connected to the memory and configured to receive a person-of-interest query representing one of the direct identifiers; a sighting-location and at least one electronic source signature detected near the sighting-location. The processing unit is configured to calculate a probability that the direct identifier within the person-of-interest query is accurate based on the signature and the secondary data set. The processing unit is also configured to generate a response message to the person-of-interest query including the probability.

The query may include a sighting-location.

The electronic source may be a cell phone, Bluetooth device, a Wi-Fi device, an automated teller machine (ATM) card, a credit card, machine-read data record representing a License plate, machine-read data record representing a government ID, a radio-frequency identification (RFID) tag, or a digital image.

The processing unit may be configured to update the secondary data set based on changes to a detected geographic location.

The processing unit may be configured to update the secondary data set based on changes to third-party databases that represent electronic credentials that associate the electronic source with one or more of the direct identifiers.

The processing unit may be configured to receive a confirmation signal that the person-of-interest was correctly identified and increase one or more weightings in the secondary data set.

The processing unit may be configured to receive a confirmation signal that the person-of-interest was incorrectly identified; and decrease one or more of the weightings in the secondary data set.

The processing unit may be configured to determine an alternative possible person-of-interest within the sighting-location based on a comparison of the signature and the person-of-interest located proximate to the signature provided in the query.

The processing unit may be configured to perform the determination if the probability from the calculating is below a threshold. The threshold may be about fifty percent.

The computing apparatus may be a server connected to a plurality of communication devices. The plurality of communication devices may be configured to constantly scan for electronic signatures and update the secondary data set based on detected electronic signatures.

Each of the above-mentioned embodiments will be discussed in more detail below, starting with an example system and device architectures of the system in which the embodiments may be practiced, followed by an illustration of processing blocks for achieving an improved technical method, device, and system for electronic identity verification in law enforcement.

Example embodiments are herein described with reference to flowchart illustrations and/or block diagrams of methods, devices and systems and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions, which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Various advantages and features consistent with the present specification will become apparent from the following description with reference to the drawings.

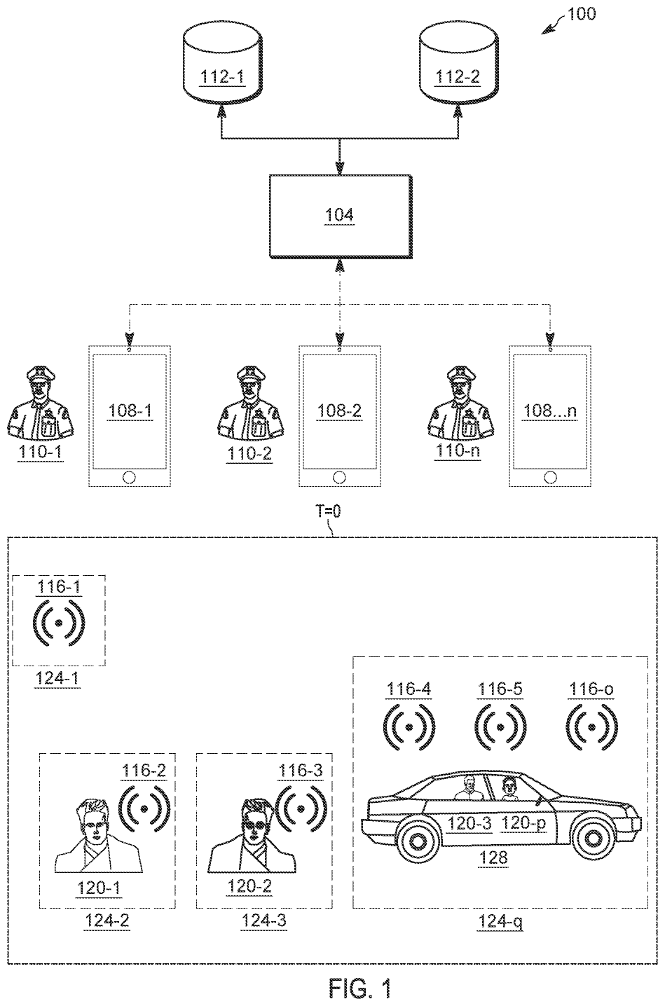

Referring now to FIG. 1, a system for electronic identity verification in law enforcement is indicated generally at 100. The locus of the system 100 is a central server 104 that is connectable via a communication link to at least one communication device 108-1, 108-2 . . . 108-n. (Collectively, the communication devices 108-1, 108-2 . . . 108-n will be referred to as the communication devices 108, and generically, as communication device 108. The reader is to understand that this form of nomenclature is used elsewhere herein.) Devices 108 are typically assigned to and under the control of individual law enforcement officials 110.

The server 104 also connects to a primary data set 112-1 and a secondary data set 112-2, the details of which will be discussed in greater detail below.

Each communication device 108 is also configured to detect electronic signatures from a plurality of electronic sources 116 which may, or may not, be sighted proximate to a plurality of potential POIs 120. Devices 108 are configured to be able to detect electronic signatures at all times and also configured to collaborate with each other and server 104. For example, devices 108 may include interfaces for Bluetooth, WiFi and NFC enabling them to detect those types of electronic signatures. Device 108 may also have interfaces to communicate with other radio frequency infrastructure to obtain such electronic signature data indirectly. As an example, device 108 cannot sense cars going through tollbooths or neighborhood entrance gates controlled by RFID, however, such tollbooths and gates can be communicatively coupled to the Internet or support a local WiFi function where device 108 (either directly and/or indirectly via server 104) can communicate with those tollbooths and gates. Other examples of indirect sensing of electronic signatures include cellular sensing, license plate readers, or other sensing technologies not commonly found as native interfaces on devices 108. Again, further details of electronic sources 116, how they are sensed and their potential proximity to various POIs 120 will be discussed in greater detail below.

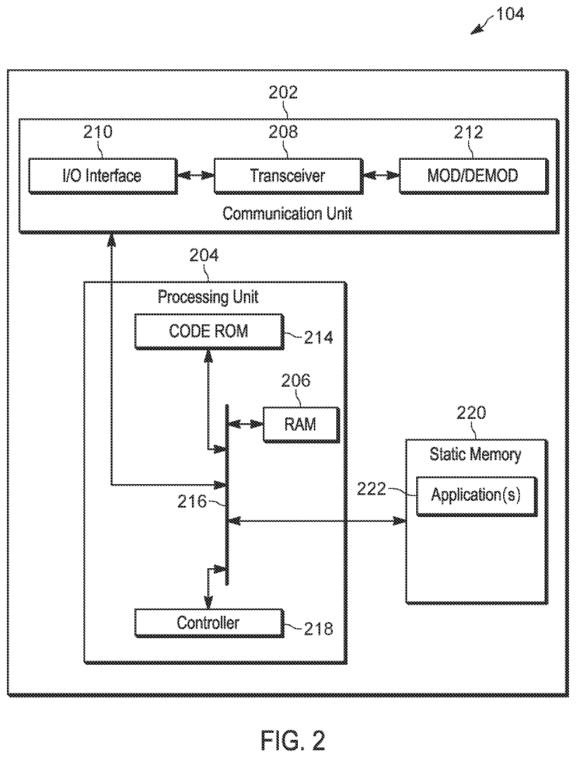

Referring now to FIG. 2, a non-limiting example of the server 104 is shown in greater detail in the form of a block diagram. While the server 104 is depicted in FIG. 2 as a single component, functionality of the server 104 may be distributed among a plurality of components, such as a plurality of servers and/or cloud computing devices. Indeed the term “server” itself is not intended to be construed in a limiting sense as to the type of computing hardware that may be used.

As depicted in FIG. 2, the server 104 comprises: a communication unit 202, a processing unit 204, a Random-Access Memory (RAM) 206, one or more wireless transceivers 208, one or more wired and/or wireless input/output (I/O) interfaces 210, a combined modulator/demodulator 212, a Read Only Memory (ROM) 214, a common data and address bus 216, a controller 218, and a static memory 220 storing at least one application 222. The controller 218 is understood to be communicatively connected to other components of the server 104 via the common data and address bus 216. Hereafter, the at least one application 222 will be interchangeably referred to as the application 222.

Furthermore, while the memories 206, 214 are depicted as having a particular structure and/or configuration, (e.g., separate RAM 206 and ROM 214), memory of the server 104 may have any suitable structure and/or configuration.

While not depicted, the server 104 may include one or more of an input device and/or a display screen, which, when present, may be communicatively coupled to the controller 218.

As shown in FIG. 2, the server 104 includes the communication unit 202 communicatively coupled to the common data and address bus 216 of the processing unit 204.

The processing unit 204 may include the Read Only Memory (ROM) 214 coupled to the common data and address bus 216 for storing data for initializing system components. The processing unit 204 may further include the controller 218 coupled, by the common data and address bus 216, to the Random-Access Memory 206 and the static memory 220.

The communication unit 202 may include one or more wired and/or wireless input/output (I/O) interfaces 210 that are configurable to communicate with other components of the system 100. For example, the communication unit 202 may include one or more wired and/or wireless transceivers 208 for communicating with other suitable components of the system 100. Hence, the one or more transceivers 208 may be adapted for communication with one or more communication links and/or communication networks used to communicate with the other components of the system 100. For example, the one or more transceivers 208 may be adapted for communication with one or more of the Internet, a digital mobile radio (DMR) network, a Project 25 (P25) network, a terrestrial trunked radio (TETRA) network, a Bluetooth network, a Wi-Fi network, for example operating in accordance with an IEEE 802.11 standard (e.g., 802.11a, 802.11b, 802.11g), an LTE (Long-Term Evolution) network and/or other types of GSM (Global System for Mobile communications) and/or 3GPP (3rd Generation Partnership Project) networks, a 5G network (e.g., a network architecture compliant with, for example, the 3GPP TS 23 specification series and/or a new radio (NR) air interface compliant with the 3GPP TS 38 specification series standard), a Worldwide Interoperability for Microwave Access (WiMAX) network, for example operating in accordance with an IEEE 802.16 standard, and/or another similar type of wireless network. Hence, the one or more transceivers 208 may include, but are not limited to, a cell phone transceiver, a DMR transceiver, P25 transceiver, a TETRA transceiver, a 3GPP transceiver, an LTE transceiver, a GSM transceiver, a 5G transceiver, a Bluetooth transceiver, a Wi-Fi transceiver, a WiMAX transceiver, and/or another similar type of wireless transceiver configurable to communicate via a wireless radio network.

The communication unit 202 may further include one or more wireline transceivers 208, such as an Ethernet transceiver, a USB (Universal Serial Bus) transceiver, or similar transceiver configurable to communicate via a twisted pair wire, a coaxial cable, a fiber-optic link, or a similar physical connection to a wireline network. The transceiver 208 may also be coupled to a combined modulator/demodulator 212.

A person skilled in the art will now recognize that the communication unit 202 provides the point of connection between the server 104, the data sets 112 and the communication devices 108 of FIG. 1. It will also now be understood that, in accordance with FIG. 1, a wireless communication link between the server 104 and the devices 108 is contemplated, and a wired communication link with data sets 112 is contemplated. With that said, the choice of wired or wireless communication links is not specifically mandated.

The controller 218 may include ports (e.g., hardware ports) for coupling to other suitable hardware components of the system 100. The controller 218 may include one or more logic circuits, one or more processors, one or more microprocessors, one or more GPUs (Graphics Processing Units), and/or the controller 218 may include one or more ASIC (application-specific integrated circuits) and one or more FPGA (field-programmable gate arrays), and/or another electronic device. In some examples, the controller 218 and/or the server 104 is not a generic controller and/or a generic device, but a device specifically configured to implement functionality for electronic identity verification. For example, in some examples, the server 104 and/or the controller 218 specifically comprises a computer executable engine configured to implement functionality for electronic identity verification.

The static memory 220 comprises a non-transitory machine readable medium that stores machine readable instructions to implement one or more programs or applications. Example machine readable media include a non-volatile storage unit (e.g., Erasable Electronic Programmable Read Only Memory (“EEPROM”), Flash Memory). In the example of FIG. 2, programming instructions (e.g., machine readable instructions) that implement the functionality of the server 104 as described herein are maintained, persistently, at the memory 220 and used by the controller 218, which makes appropriate utilization of volatile storage (e.g. RAM 206) during the execution of such programming instructions.

Furthermore, the memory 220 stores instructions corresponding to the at least one application 222 that, when executed by the controller 218, enables the controller 218 to implement functionality for electronic identity verification, including but not limited to, the blocks of certain methods discussed elsewhere herein. Furthermore, while not depicted, the data sets 112 may be stored, and/or partially stored, within the memory 220.

In illustrated examples, when the controller 218 executes the one or more applications 222, the controller 218 is enabled to perform a method for corroborating an identification of a person-of-interest comprising maintaining a primary data set representing a plurality of direct identifiers each respective to a different person-of-interest of a plurality of persons of interest. The method also comprises maintaining a secondary data set representing at least one indirect identifier including: an electronic source; a geographic location of the electronic source; and a weighting representing a likelihood that presence of each indirect identifier is proximate to one of the persons-of-interest. The method also comprises receiving a person-of-interest query representing one of the direct identifiers; a sighting-location and at least one electronic source signature proximate to the sighting-location, calculating a probability that the direct identifier within the person-of-interest query is accurate based on the signature and the secondary data set and generating a response message to the person-of-interest query including the probability.

The query may include a sighting-location.

The electronic source may be a cell phone, Bluetooth device, a Wi-Fi device, an automated teller machine (ATM) card, a credit card, machine-read data record representing a License plate, machine-read data record representing a government ID, a radio-frequency identification (RFID) tag, or a digital image.

Updating the secondary data set may be automatic and continuous based on changes to a detected geographic location.

Updating the secondary data set may be based on changes to third-party databases that represent electronic credentials that associate the electronic source with one or more of the direct identifiers.

The method may further comprise receiving a confirmation signal that the person-of-interest was correctly identified and increasing one or more weightings in the secondary data set.

The method may further comprise receiving a confirmation signal that the person-of-interest was incorrectly identified; and decreasing one or more of the weightings in the secondary data set.

The method may further comprise determining an alternative possible person-of-interest within the sighting-location based on a comparison of the signature and the person-of-interest located proximate to the signature provided in the query.

The method may further comprise the determining being performed if the probability from the calculating is below a threshold. The threshold may be about fifty percent.

Alternatively, or in addition, the application 222 may include machine learning and/or deep-learning based algorithms and/or neural networks, and the like, which are trained to improve the electronic identity verification approaches discussed herein. Furthermore, in these examples, the application 222 may be operated by the controller 218 in a training mode to train the machine learning and/or deep-learning based algorithms and/or neural networks of the application 222 in accordance with the teachings herein.

The one or more machine-learning algorithms and/or deep learning algorithms and/or neural networks of the application 222 may include, but are not limited to: a generalized linear regression algorithm; a random forest algorithm; a support vector machine algorithm; a gradient boosting regression algorithm; a decision tree algorithm; a generalized additive model; neural network algorithms; deep learning algorithms; evolutionary programming algorithms; Bayesian inference algorithms; reinforcement learning algorithms, and the like. However, generalized linear regression algorithms, random forest algorithms, support vector machine algorithms, gradient boosting regression algorithms, decision tree algorithms, generalized additive models, and the like may be preferred over neural network algorithms, deep learning algorithms, evolutionary programming algorithms, and the like. However, generalized linear regression algorithms, random forest algorithms, support vector machine algorithms, gradient boosting regression algorithms, decision tree algorithms, generalized additive models, and the like may be preferred over neural network algorithms, deep learning algorithms, evolutionary programming algorithms, and the like, in public safety environments such as law enforcement. To be clear, any suitable machine-learning algorithm and/or deep learning algorithm and/or neural network is within the scope of present examples.

Referring again to FIG. 1, while details of the devices 108 are not depicted, the devices 108 may have components similar to the server 104 but adapted for their respective functionalities. For example, the devices 108 may include respective display screens for rendering notifications, and/or respective devices and/or applications for registering a location with the server 104, and the like. The devices 108 may include various input devices, such as a microphone for receiving voice instructions, and various output devices, such as a speaker or headset interface, for delivering voice responses. The devices 108 have a form factor and interfaces that make them suitable for use by law enforcement personnel 110, and accordingly, one device 108 is shown respective to each personnel 110.

It is to be understood that specific functions within each of server 104, devices 108 and datasets 112 may be implemented within different components of system 100, and the specific embodiments described herein are examples.

FIG. 1 also shows a plurality of electronic sources 116 and persons-of-interest 120 (also referred to collectively as POIs 120 and generically as POI 120) which are non-respectively spread across a plurality of locations 124. Notably, electronic source 116-1 is shown located within location 124-1. POI 120-1 and electronic source 116-2 are shown located within location 124-2. POI 120-2 and electronic source 116-3 are shown located within location 124-3. POI 120-3 and POI 120-p are shown inside a vehicle 128 and are proximate to electronic sources 116-4, 116-5 and 116-o within location 124-q. This is a simplified example arrangement used for the purposes of explanation and reflect an example state at in initial time stamp, represented in FIG. 1 as “T=0”. It is to be understood therefore that system 100 operates continuously and that the arrangements of POI 120 and sources 116 will change locations 124 over time.

Thus, a person of skill in the art, with the benefit of this specification, will appreciate that system 100 is intended to operate whereby the locations 124 of each POI 120 and each electronic source 116 are constantly changing and that system 100 assists with identity verification of different POIs 120 through the technological implementations herein in a fashion that efficiently utilizes the resources of server 104, devices 108 and the communication networks they operate over, so as to allow the server 104 and the devices 108 to use the remaining computing resources of system 100 for other functions thus overall improving optimization of the computing resources of system 100.

Turning now to the data sets 112, collectively they are configured to maintain identifiers respective to each POI 120 and each electronic source 116 and the respective location 124 of the electronic source, recognizing that such locations 124 are expected to constantly change. Technologically, data sets 112 may be implemented through storage directly inside the static memory 220 of FIG. 2, as discussed above. However, it is presently contemplated that data sets 112 are implemented in memory devices that are remote to the server 104, in any suitable computing platform based on, for example, a suitably modified version of the specific processing, memory and communication components described in relation to the server 104 in FIG. 2. The memory devices used to house the data sets 112 may also be stand-alone database servers, complete with non-volatile storage to maintain the data itself, and processing units and volatile storage to respond to queries, additions, updates, deletions and other standard database functions that enable maintenance of the data sets 112.

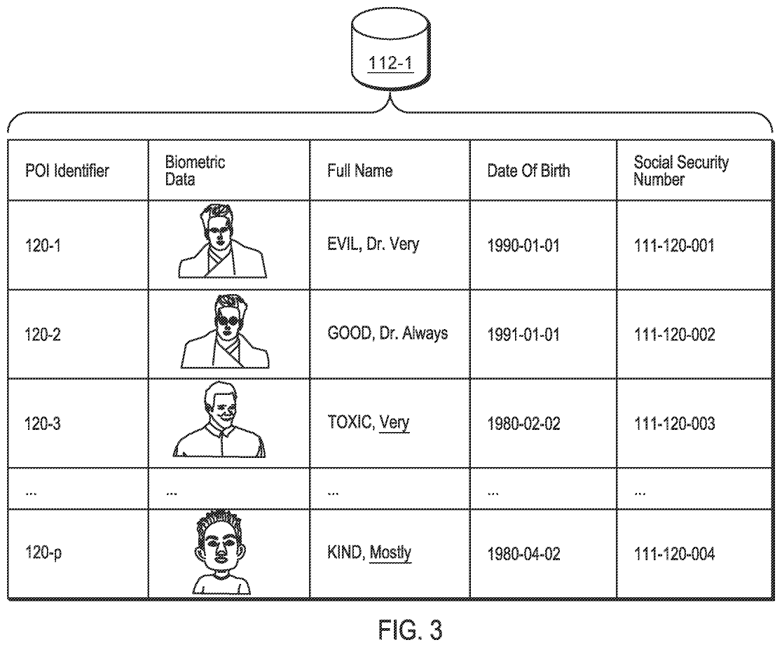

Referring now to FIG. 3, data set 112-1 is configured to maintain a primary data set representing at least one direct identifier that is respective to each POI 120. The nature of the direct identifier is not particularly limited but typically reflects information that follows the POI 120 and unambiguously (or at least as unambiguously as possible) is associated with the individual's identity or personhood. Data set 112-1 can be identical to, based on, or derived from the contents of one more of any known databases that maintains lists of individuals such as live birth registers, taxation rolls, social security number registers, driver's license registers, property ownership registers, criminal databases and the like. The concept of direct identifiers for a POI 120 would thus include, for example, data that collectively provides for direct identification, such as a full legal name, date of birth, address of residence, citizenship, social security number, driver's license numbers and biometric information. Not all of this information may be required, simply enough information to positively provide a direct identification of a given POI 120, assuming the data about the POI is actually part of the data set 112-1. Also, some data, such as birth dates, are provided not as a means of primary identification, such as a person's legal name, but as an additional factor to support the accuracy of such primary identification. Overall, having more data in data set 112-1 can increase the overall reliability, or probability, of accurate identity verification in system 100.

Depending on the level of regulatory controls imposed on system 100 that are designed to protect civil rights and privacy, it should be noted that the inclusion of a POI in data set 112-1 may be restricted to persons-of-interest according to a strict definition of individuals that are potentially the subject of a criminal investigation. By the same token, data set 112-1 could be expansive to include an entire population regardless of whether the individual is of interest to a law enforcement agency. Such decisions are agnostic to the technological benefits of efficient use of computing resources in system 100 as afforded by the present specification.

In FIG. 3, the example data set 112-1 includes at least the POIs 120 from FIG. 1, with the ellipses (i.e. “ . . . ” in the fourth row of the table in FIG. 3) representing that the data set 112-1 may include a much larger data set of POIs. The non-limiting example data set 112-1 in FIG. 3 includes biometric data such as one or more of a facial pattern, finger print, DNA sample, voice signature or retina signature. Additionally, the data set 112-1 includes the full legal name, the date of birth and the social security number or other government identification number such as a driver's license. Provided the data set 112-1 is sufficiently complete and unique, searches of data set 112-1 can be performed based on querying any of these data until there is a reasonable reliable accurate identification of a single POI 120. Again, the data set 112-1 in FIG. 3 is merely an example and may be structured differently to include fewer, or more, or altogether different fields as deemed suitable for providing direct identifiers of persons of interest.

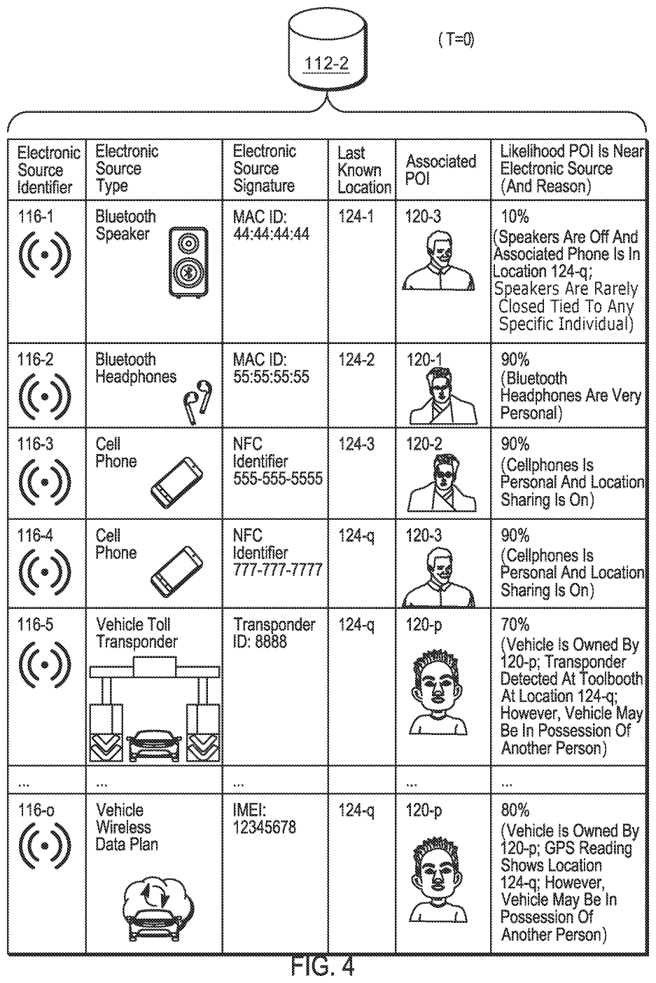

Referring now to FIG. 4, data set 112-2 includes at least one indirect identifier including an identification of an electronic source, a last-known geographic location of each electronic source, and a weighting representing a likelihood that the presence of each electronic source is proximate to one or more persons-of-interest. Recall from FIG. 1 the inclusion of an illustrative example set of six electronic sources 116. Electronic sources 116 are intentionally described in generic fashion, as the types of possible electronic sources 116 are not fixed and are expected to grow. Currently known electronic sources 116 include an electronic device that can be detected as having a unique digital signature. Non-limiting examples of electronic sources 116 include cellular telephones, Bluetooth devices, Wi-Fi devices, an automated teller machine (ATM) card, a credit card, license plates optically read by a machine, printed government IDs optically read by a machine, radio-frequency identification (RFID) tags, or digital images. Other examples of electronic sources include, from a phone, Bluetooth/WiFi/NFC Logs from a previously confirmed presence with a POI 120. Other examples include cellphone triangulation combined with carrier ownership records; Bluetooth Earbuds based on logs from a previously confirmed presence of a phone belonging to a POI 120; and a Bluetooth Loudspeaker based on logs from a previously confirmed presence of a phone belonging to a POI 120. In the context of vehicles, other examples of electronic sources can include electronic car tollbooth system registration records, automatic license plate readers (ALPR) combined with state vehicle registration records; vehicles equipped with WiFi or TPMS logs from previous confirmed presence due to traffic stops and vehicle manufacturer service registration records.

The weighting representing a likelihood that the presence of each electronic source is proximate to one or more persons-of-interest can be determined in many ways. In one example, the weighting is based on:

(Likelihood the electronic source is associated with just one person)×(Number of times that person seen with that electronic source).

Another factor that can be considered in the weighting is the certainty that comes from the type of electronic source versus the certainty that comes from known encounters of when the POI 120 and the electronic source 116 are together. Regardless of the exact type, the electronic signatures emitted from sources 116 are themselves capable of detection (by, for example, device 108 or, as discussed above, other devices that can communicate the detected electronic signature data to device 108) in association with their geographic location 124, with the identity of the electronic source 116 and location being transmissible and stored in data set 112-2, which additionally maintains a weighting representing a likelihood that a given POI 120 is also at the same location.

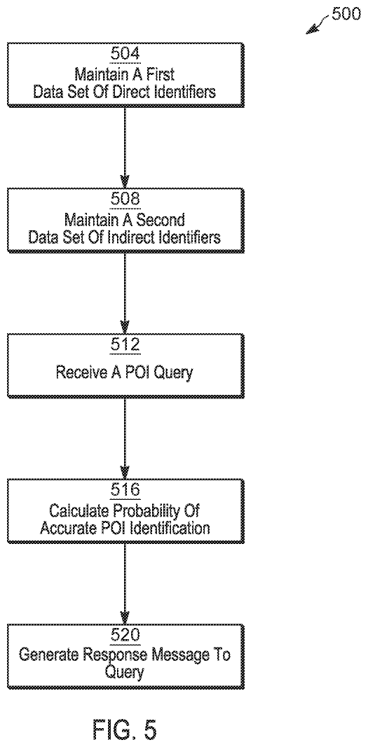

Referring now to FIG. 5, a method for electronic identity verification in law enforcement is provided in the form of a flowchart indicated generally at 500. For convenience, the method in FIG. 5 will hereafter be referred to as method 500. This nomenclature will be used elsewhere. Method 500 can be implemented as part of application 222 from FIG. 2 or according to the variants previously discussed as to how methods can be implemented in system 100. It should be reemphasized however that while method 500 will be described in terms of its implementation on system 100, variants in method 500 and system 100 are contemplated.

At block 504, a first data set comprising direct identifiers is maintained within system 100 or a variant thereon. The means by which block 504 is implemented is not particularly limited, but in accordance with the specific examples of this specification, block 504 may be implemented according to the prior description of first data set 112-1 described in relation to FIG. 3.

At block 508, a second data set comprising indirect identifiers is maintained within system 100 or a variant thereon. The means by which block 508 is implemented is not particularly limited, but in accordance with the specific examples of this specification, block 508 may be implemented according to the prior description of second data set 112-2 described in relation to FIG. 4.

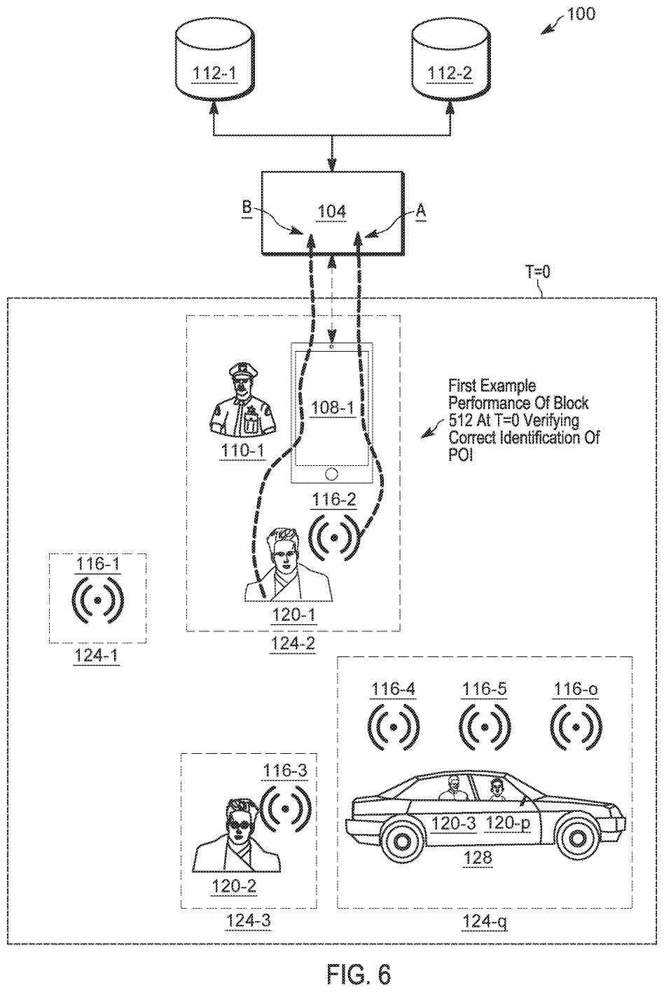

At block 512, a person-of-interest query is received. The goal of the query is to seek verification of the identity of a person of interest, and thus a direct identifier of the person-of-interest is included in the query. Additionally, the query may include a sighting-location and a) an electronic signature captured from one of the electronic sources or b) recent electronic signature data previously captured by another electronic device, not shown. To illustrate example performance of block 512 reference is made to FIG. 6 which is based on FIG. 1, whereby law enforcement personnel 110-1 and the accompanying device 108-1 has moved to location 124-2 and is engaging with POI 120-1. Data flow in the form of dashed lines are shown. One dashed line “A” shows device 108-1 detecting the signature of source 116-2 and transmitting that signature to server 104. (Note that, commonly, the electronic signature of electronic sources 116 are being continuously captured throughout system 100 and not particularly necessarily tied to the specific event being described in relation to block 512.) Another dashed line “B” represents law enforcement personnel 110-1 interacting with POI 120-1 and personnel 110-1 is assuming that personnel 110-1 has recognized POI 120-1, by inputting a preliminary identification of POI 120-1 into device 108-1 which is also transmitted to server 104. The location of device 108-1 is persistently being updated at device 108-1 and being transmitted to server 104, and thus location 124-2 is also being transmitted (or is already known) to server 104.

To summarize, according to the example in FIG. 3, FIG. 4, and FIG. 6 at block 512, the query includes:
a. one or more of the direct identifiers from FIG. 3 for POI 120-1, such as the name “Dr. Very EVIL” along with one more or data such as biometric data, the birthdate “1990-01-01” and/or the social security number “111-120-001”.
b. one or more of the indirect identifiers associated electronic signature of source 116-2, such as the MAC ID: 55:55:55:55 for that pair of Bluetooth headphones.
c. the sighting-location (e.g. The location where law enforcement personnel 110-1 sighted POI 120-1), that location being location 124-2 in accordance with the example in FIG. 6.

At block 512, a person-of-interest query is received. The goal of the query is to seek verification of the identity of a person of interest, and thus a direct identifier of the person-of-interest is included in the query. Additionally, the query will include a sighting-location and an electronic signature captured from one of the electronic sources. To illustrate example performance of block 512, reference is made to FIG. 6 which is based on FIG. 1, whereby law enforcement personnel 110-1 and the accompanying device 108-1 has moved to location 124-2 and is engaging with POI 120-1. (However, it is to be emphasized that the electronic signature of electronic source 116-2 associated with POI 120-1 will most often have been previously captured and automatically sent to server 104 for analysis in relation to the current engagement with POI 120-1). Data flow in the form of dashed lines are shown. One dashed line (indicated at arrow “A”) shows device 108-1 detecting the signature of source 116-2 at device 108-1 and transmitting that signature to server 104. Another dashed line (indicated at arrow “B”) represents law enforcement personnel 110-1 interacting with POI 120-1 and inputting a preliminary identification of POI 120-1 into device 108-1 which is also transmitted to server 104. The location of device 108-1 is persistently being updated at device 108-1 and being transmitted to server 104, and thus location 124-2 is also being transmitted (or is already known) to server 104.

At block 516, the probability that the identification of the POI from the query at block 512 is calculated. According to our example in relation to system 100, the probability is calculated by controller 218 in server 104 based on the contents of the query from block 512 and an examination of the information maintained in data sets 112. An examination of data set 112-2 from FIG. 3 results in a calculation that source 116-2 is in fact associated with POI 120-1 and that there is a ninety percent (90%) likelihood that POI 120-1 is proximate to source 116-2. Further details regarding the identity of POI 120-1 can also be gleaned from an examination of data set 112-1.

At block 520, a response message is generated to the query from block 512 that is based on the calculation at 516. Performance of block 520 typically involves controlling an output device according to the response, which in the example of system 100 includes sending a reply message from server 104 to device 108-1 that includes an indication that there is a ninety percent probability that POI 120-1 has been correctly identified as “Dr. Very EVIL” given that Dr. Very Evil's personal Bluetooth headphones were detected within the same physical location 124-2 as Dr. Very EVIL.

Controlling the output device at block 520 can also comprise generating a visual or audible message on device 108-1, and can also include more elaborate controls such as activating a drone to surveil POI 120-1, or automatically activating a body camera on law enforcement personnel 110-1, or server 104 being configured to automatically call for backup for the law enforcement personnel 110-1 or automatically activating a haptic feedback device worn by law enforcement personnel 110-1 that silently signals via a predetermined vibration pattern to the law enforcement personnel 110-1 that the POI is dangerous. Other examples will now occur to those skilled in the art.

Persons skilled in the art can now appreciate other example scenarios based on the example set of sources 116, POIs 120 and locations 124 in FIG. 1, FIG. 3, FIG. 4 and FIG. 5, noting that those nodes of this system will constantly change requiring periodic updates to data sets 112 over different time stamps (T=x), and causing different calculations to occur at block 516 based on different queries received at block 512.

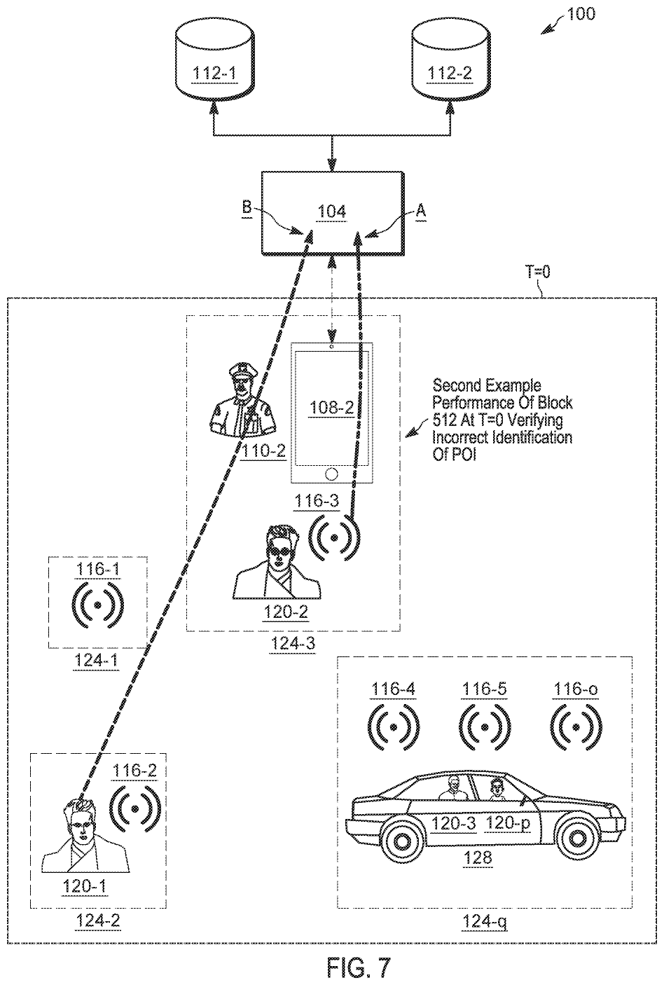

For example, a variant on the example of FIG. 6 is shown in FIG. 7. In FIG. 6, the example showed a verification (i.e. indicated a strong probability) that the law enforcement personnel 110-1 had correctly identified the POI 120-1. FIG. 7 is an opposite example, where the law enforcement personnel 110-2 incorrectly identifies the POI 120-2 at location 124-3. In FIG. 7, law enforcement personnel 110-2 enters the location 124-3 at T=0, and visually mistakes POI 120-2 for POI 120-1 due their similar physical appearance. Thus, in FIG. 7, dashed line “A” shows device 108-1 detecting the signature of source 116-3 and transmitting that signature to server 104. (Again, noting that, commonly, the electronic signature of electronic sources 116 are being continuously captured throughout system 100 and not particularly necessarily tied to the specific event being described in relation to block 512.) The other dashed line “B” represents that law enforcement personnel 110-2 believes that personnel 110-2 is interacting with POI 120-1 (“Dr. Very EVIL”) and thus personnel 110-2 is assuming that personnel 110-2 has recognized POI 120-1 by inputting a preliminary identification of POI 120-1 into device 108-2. However, in fact, personnel 110-2 is really proximate to POI 120-2 (Dr. Always GOOD) and has mistaken POI 120-2 (Dr. Always GOOD) for POI 120-1 (Dr. Very EVIL). With the benefit of the teachings of this specification, server 104 is configured to alert law enforcement personnel 110-2 that there is a high probability that law enforcement personnel 110-2 has mistaken POI 120-2 for POI 120-1, thereby mitigating resulting harm to POI 120-2, as well as reducing data traffic and electronic resource consumption of system 100 that could result from erroneously mobilizing backup support for personnel 110-2 to apprehend the wrong POI. To elaborate, law enforcement personnel 110-2 sends the following query at block 512:
a. one or more of the direct identifiers from FIG. 3 for POI 120-1, such as the name “Dr. Very EVIL” along with one more or data such as biometric data, the birthdate “1990-01-01” and/or the social security number “111-120-001”. (However, this would be an error since the actual POI 120 in location 124-3 is really POI 120-2.)
b. one or more of the indirect identifiers associated with electronic signature of source 116-3, such as the NFC identifier 555-555-5555 for the cell phone belonging to POI 120-2 that was detected by device 108-2. (Note that referring to a specific reference to the indirect identifier being sent specifically here at block 512 is for illustrative convenience, as these indirect identifiers are commonly automatically and continuously sent to server 104 prior to the specific query at block 512.)
c. the sighting-location (e.g., The location where law enforcement personnel 110-2 has sighted POI 120-2), that location being location 124-3 in accordance with the example in FIG. 7.

Continuing with the example of FIG. 7, the query from FIG. 7, would lead to a probability calculation at block 516 that it is unlikely that the POI is “Dr. Very EVIL”. The probability calculation can be derived from examining the entries in data sets 112, relating to location 124-3, source 116-3, POI 120-2 (Dr. Always GOOD) and POI 120-1 (Dr. Very EVIL). Those entries would reveal that POI 120-2 (Dr. Always GOOD) is at location 124-3 associated with source 116-3, while POI 120-1 (Dr. Very EVIL) is more likely associated with a different location 124-2. Thus, the response message at block 520 back to personnel 110-2 would indicate that it is unlikely that the POI in location 124-3 is POI 120-1 (Dr. Very EVIL). Indeed, such a response message may also return a message that it the POI within location 124-3 is more likely to be POI 120-2 (Dr. Always GOOD).

At this point, however, it is important to note that in many embodiments the specific association in data set 112-2 between a POI 120 and an electronic source 116 with a last known location need only play a supporting function in identity verification. Various examples illustrate this concept. If a source 116, such as the Bluetooth speaker source 116-1, remains fixed in one location, it may be an indication of poor association with a POI 120, because any POI 120 could stand next to such a fixed source 116. Accordingly, the last known location of an electronic source 116 in data set 112-2 need not play a strong role in the strengthening of probability of a current location sighting in a calculation of probability at block 516; rather the more valuable knowledge in data set 112-2 is the fact of the ongoing association between a given electronic source 116 and a given POI 120 that, over time, suggests a higher probability that the presence of an electronic source 116 at any location 124 is likely indicative of a corresponding presence of a given POI 120 at the same location 124. By the same token, if a query is issued by a personnel 110 for a suspected sighting of POI 120-1 and system 100 “knows” that the electronic source 116 belonging to POI 120-1 is located on the other side of town, then it is unlikely that the suspected sighting of POI 120-1 is accurate.

More elaborate examples will now occur to those skilled in the art, along with an appreciation of how system 100 may be massively scaled. Notably, referring back to FIG. 1, law enforcement personnel 110 using a respective device 108 while interacting with vehicle 128 in location 124-q will be proximate to three separate electronic sources 116-4, 116-6 and 116-o and two POIs 120, namely POI 120-3 and 120-p. System 100 combined with method 500 can result in probability calculations that increase the likelihood of making a correct identification of POI 120-3 (Very TOXIC) and 120-p (Mostly KIND), based on the sources 116 stored in data set 112-2 and the direct identifiers stored in data set 112-1. Furthermore, a validation based on probabilities of correct identification of POI 120-3 (Very TOXIC) within location 124-q may be bolstered by an absence, namely the absence of POI 120-3 at location 124-1 because electronic source 116-1 does not show any connection with the phone electronic source 116-4 that is associated with POI 120-3 (Very TOXIC) in data set 112-2

Persons skilled in the art will also now appreciate that frequent and dynamic updating of data sets 112, and in particular data set 112-2, bolsters the identity verification benefits of system 100. Thus, an array of devices that constantly monitor the locations 124 of various electronic sources 116, coupled to databases that update the POIs 120 who are associated with those electronic sources 116, can lead to an increased confidence in the accuracy of the data sets 112 and accompanying identity verifications offered by system 100. Additionally, law enforcement personnel 110 or other individual may periodically affirm or deny the accuracy of the probability calculations made at block 516 once they have had additional time with the POI 120 and to properly question them and study the identification documents which they carry. These affirmations or denials can be fed back into data set 112-2, particularly the probability likelihood data (which may also be referred to as weightings or relationship weightings) maintained in the last column of FIG. 4 of data set 112-2, thereby increasing the quality of data set 112-2 and future calculations made at block 516. Accordingly, persons skilled in the art will now also appreciate the novel machine learning aspect of the present specification. Indeed, one or more machine-learning algorithms for implementing a machine-learning feedback loop for training the one or more machine-learning algorithms may be provided, where the machine-learning feedback loop comprises processing feedback indicative of an evaluation of weightings maintained within data set 112-2, as determined by the one or more machine-learning algorithms.

Indeed, relationship weightings may be provided as a training set of feedback for training the one or more machine-learning algorithms to better determine these relationship weightings. Such a training set may further include factors that lead to such determinations, including, but not limited to, manually affirming or denying identity verifications of different POIs 120 in association with the presence of various electronic sources 116. Such a training set may be used to initially train the one or more machine learning algorithms.

Further, one or more later determined relationship weightings may be labelled to indicate whether the later determined relationship weightings, as generated by the one or more machine-learning algorithms, represent positive (e.g., effective) examples or negative (e.g., ineffective) examples.

For example, the one or more machine-learning algorithms may generate a probability score, for example on the percentage scale of zero to 100 in FIG. 4, with higher scores indicating a higher level of respective confidence in predicting and/or later determining an association between the presence of an electronic source 116 and a given POI 120; hence, data set 112-2 may be labelled with the scores in feedback to the one or more machine-learning algorithms.

Regardless, when weightings in data set 112-2 are provided to one or more machine-learning algorithms in the machine-learning feedback loop, the one or more machine-learning algorithms may be better trained to determine future relationship weightings on the basis of the labels and/or the scores.

In other examples, probability weightings generated by one or more machine-learning algorithms may be provided to a feedback computing device (not depicted), which may be a component of the system 100 and/or external to the system 100 that has been specifically trained to generate labels and/or scores for probability weightings in data set 112-2, and/or verify labels and/or scores of those probability weightings. Such a feedback computing device may generate and/or verify labels and/or scores and provide the generated and/or verified labels and/or scores as feedback (and/or at least a portion of the feedback, such as the labels) back to the server 104 for storage (e.g., at the memory 220) until a machine-learning feedback loop is implemented. Put another way, labels and/or scores of feedback for a machine learning algorithm may be generated and/or provided in any suitable manner and/or by any suitable computing device and/or communication device.

Hence, by implementing a machine-learning feedback loop, more efficient operation of the server 104 may be achieved, and/or a change in operation of the server 104 may be achieved, as one or more machine-learning algorithms are trained to better and/or more efficiently determine the probability weightings in data set 112-2.

As will now be apparent from this detailed description, the operations and functions of electronic computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, cannot control a display screen, cannot implement a machine learning algorithm, nor implement a machine learning algorithm feedback loop, and the like).

In the foregoing specification, specific embodiments have been described. However, one of ordinary skill in the art will now appreciate that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. Furthermore, references to specific percentages should be construed as being “about” the specified percentage.

A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or system described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the different approaches could be used.

Moreover, embodiments can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (ICs) with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method for corroborating an identification of a person-of-interest comprising:
maintaining a primary data set representing:
a plurality of direct identifiers each respective to a different person-of-interest of a plurality of persons-of-interest;
maintaining a secondary data set representing:
at least one indirect identifier including:
an electronic source;
a geographic location of the electronic source; and
a weighting representing a proximity likelihood for the indirect identifier in relation to one of the persons-of-interest;
receiving a person-of-interest query representing one of the direct identifiers; a sighting-location and at least one electronic source signature detected near the sighting-location;
calculating a probability that the direct identifier within the person-of-interest query is accurate based on the signature and the secondary data set; and
generating a response message to the person-of-interest query including the probability.

2. The method of claim 1 wherein the electronic source is a cell phone, Bluetooth device, a Wi-Fi device, an automated teller machine (ATM) card, a credit card, machine-read data record representing a License plate, machine-read data record representing a government ID, a radio-frequency identification (RFID) tag, or a digital image.

3. The method of claim 1 further comprising updating the secondary data set based on changes to a detected geographic location.

4. The method of claim 1 further comprising updating the secondary data set based on changes to third-party databases that represent electronic credentials that associate the electronic source with one or more of the direct identifiers.

5. The method of claim 1 further comprising:
receiving a confirmation signal that the person-of-interest was correctly identified; and
increasing one or more weightings in the secondary data set.

6. The method of claim 1 further comprising:
receiving a confirmation signal that the person-of-interest was incorrectly identified; and
decreasing one or more of the weightings in the secondary data set.

7. The method of claim 1 further comprising determining an alternative possible person-of-interest within the sighting-location based a comparison of the signature and the person-of-interest located proximate to the signature provided in the query.

8. The method of claim 7 wherein the determining is performed if the probability from the calculating is below a threshold.

9. The method of claim 8 wherein the threshold is about fifty percent.

10. A computing apparatus for corroborating an identification of a person-of-interest comprising:
a memory for maintaining a primary data set representing:
a plurality of direct identifiers each respective to a different person-of-interest of a plurality of persons of interest;
the memory for maintaining a secondary data set representing:
at least one indirect identifier including:
an electronic source;
a geographic location of the electronic source; and
a weighting representing a proximity likelihood for the indirect identifier in relation to one of the persons-of-interest;
a processing unit connected to the memory and configured to receive a person-of-interest query representing one of the direct identifiers; a sighting-location and at least one electronic source signature detected near the sighting-location;
the processing unit configured to calculate a probability that the direct identifier within the person-of-interest query is accurate based on the signature and the secondary data set; and
the processing unit configured to generate a response message to the person-of-interest query including the probability.

11. The computing apparatus of claim 10 wherein the electronic source is a cell phone, Bluetooth device, a Wi-Fi device, an automated teller machine (ATM) card, a credit card, machine-read data record representing a License plate, machine-read data record representing a government ID, a radio-frequency identification (RFID) tag, or a digital image.

12. The computing apparatus of claim 10 further comprising the processing unit being configured to update the secondary data set based on changes to a detected geographic location.

13. The computing apparatus of claim 10 further comprising the processing unit being configured to update the secondary data set based on changes to third-party databases that represent electronic credentials that associate the electronic source with one or more of the direct identifiers.

14. The computing apparatus of claim 10 further comprising the processing unit being configured to receive a confirmation signal that the person-of-interest was correctly identified and increase one or more weightings in the secondary data set.

15. The computing apparatus of claim 10 further comprising the processing unit being configured to receive a confirmation signal that the person-of-interest was incorrectly identified;
and decrease one or more of the weightings in the secondary data set.

16. The computing apparatus of claim 10 further comprising the processing unit being configured to determine an alternative possible person-of-interest within the sighting-location based a comparison of the signature and the person-of-interest located proximate to the signature provided in the query.

17. The computing apparatus of claim 16 further comprising the processing unit being configured perform the determination if the probability from the calculating is below a threshold.

18. The computing apparatus of claim 17 wherein the threshold is about fifty percent.

19. The computing apparatus of claim 10 wherein the computing apparatus is a server connected to a plurality of communication devices.

20. The computing apparatus of claim 19 wherein the plurality of communication devices are configured to constantly scan for electronic signatures and update the secondary data set based on detected electronic signatures.
